(19) United States
(12) Patent Application Publication
(10) Pub. No.: US 2017/0344226 A1
(43) Pub. Date: Nov. 30, 2017

(54) ELECTRONIC DEVICE AND CONTROL METHOD THEREOF

(71) Applicant: Samsung Electronics Co., Ltd., Suwon-si (KR)

(72) Inventors: Suresh Kumar GUDLA, Bangalore (IN); Joy BOSE, New Delhi (IN)

(21) Appl. No.: 15/598,866

(22) Filed: May 18, 2017

(30) Foreign Application Priority Data
May 25, 2016 (IN) 201641017996

(51) Int. Cl. G06F 3/0481; H04M 1/725; G06F 3/0484; H04L 29/06; G06Q 20/40; H04W 12/06; H04L 29/08; G06K 9/00

(52) U.S. Cl. CPC G06F 3/04817; H04W 12/06; H04M 1/72583; H04L 67/28; H04L 67/26; G06F 3/04842; H04L 63/0861; G06Q 20/405; G06Q 20/40145; H04L 67/02; G06K 9/00892

(57) ABSTRACT

An electronic apparatus and a controlling method thereof are provided. The method includes receiving a notification message regarding a content from an external server, displaying a notification message including the content provided from the external server and a user interface (UI) element regarding the content in one area of a notification area, in response to a user input being detected on the UI element, performing an operation corresponding to the selected UI element while the notification area is displayed, and displaying a graphic UI (GUI) corresponding to the operation on the notification message.

### CROSS-REFERENCE TO RELATED APPLICATION(S)

This application claims the benefit under 35 U.S.C. §119(a) of an Indian provisional patent application filed on May 25, 2016 in the Indian Intellectual Property Office and assigned Serial number 201641017996 and an Indian patent application filed on Oct. 20, 2016 in the Indian Intellectual Property Office and assigned Serial number 201641017996, the entire disclosure of each of which is hereby incorporated by reference.

### TECHNICAL FIELD

The present disclosure relates to an electronic apparatus and a control method thereof. More particularly, the present disclosure relates to a method and an apparatus for managing push messages.

### BACKGROUND

In the related art, consider a scenario where a user of a mobile device (i.e., an electronic apparatus) receives a push message, such as content advertisements (i.e., television (TV) advertisement) from a content provider, such as e-commerce website or any other application related thereof. Thereafter, the user selects the push message to buy a product (i.e., the TV). When the user selects the push message, the mobile device may launch a browser application with a uniform resource locator (URL) of the e-commerce website or an e-commerce application associated (i.e., a native app) with the mobile device. The launched URL opens the selected product of the push message in the browser or the e-commerce application associated with the mobile device.

Due to latency in providing the content (i.e., a product) by the content provider through the e-commerce application or from the browser application with URL, the user may get deviated from buying the selected product. Further, as due to plethora of deals available in launched page of the product accompanying the user selected product, navigating within the pages may also allow the user to get deviated from buying the desired product. Thus, the user may find it difficult in purchasing the product due to the aforesaid occurrences or circumstances involved in the purchasing process of the product received by way of the push message.

Therefore, a need exists for an electronic apparatus and a control method for managing a push message.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic apparatus and a control method for managing a push message.

In accordance with an aspect of the present disclosure, an electronic apparatus is provided. The electronic apparatus includes a display, at least one processor, and a memory configured to store one or more computer programs executed by the at least one processor, wherein the one or more computer programs include an instruction to, in response to a notification message regarding a content being received from an external server, control the display to display a notification message including an image of the content and a user interface (UI) element regarding the content in one area of a notification area, an instruction to, in response to a user input being detected on the UI element, control to perform an operation corresponding to the selected UI element while the notification area is displayed, and an instruction to control the display to display a graphic UI (GUI) corresponding to the operation on the notification message.

In accordance with another aspect of the present disclosure, a controlling method of an electronic apparatus is provided. The method includes receiving a notification message regarding a content from an external server, displaying a notification message including the content provided from the external server and a UI element regarding the content in one area of a notification area, in response to a user input being detected on the UI element, performing an operation corresponding to the selected UI element while the notification area is displayed, and displaying a GUI corresponding to the operation on the notification message.

As described above, the various embodiments provide an electronic apparatus and a control method provides a user of the electronic apparatus with an interactive push message service which enables the user to explore the content and perform the at least one action within the notification area, without navigating into any other application (i.e., a browser application, a native application of the content provider, and the like). The at least one action may include, for example, navigating to at least one of previously received push message, view the details of the content (i.e., a product), buy the product, and the like.

In addition, the electronic apparatus and control method provides the user of the electronic apparatus with a customized push message which includes the content and the at least one interactive graphical element to perform at least one action within the notification area of the mobile device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a sequence diagram illustrating a method for managing a push message in which a user accesses content of the push message in a browser application according to the related art;

FIG. 2 is a sequence diagram illustrating a method for managing a push message in which a user accesses content of the push message in a notification area of a mobile device according to an embodiment of the present disclosure;

FIG. 3 illustrates blocks of a content provider apparatus for managing a push message according to an embodiment of the present disclosure;

FIG. 4 illustrates blocks of a gateway server apparatus for managing a push message according to an embodiment of the present disclosure;

FIG. 5 illustrates blocks of a mobile device for managing a push message according to an embodiment of the present disclosure;

FIG. 6 is a flowchart illustrating a method for managing a push message by a mobile device according to an embodiment of the present disclosure;

FIG. 7 is a sequence diagram illustrating a method in which a push message is customized by a content provider apparatus according to an embodiment of the present disclosure;

FIG. 8 is a sequence diagram illustrating a method in which a push message is customized by a gateway server apparatus according to an embodiment of the present disclosure;

FIG. 9 is a sequence diagram illustrating a method in which a push message is customized by a mobile device according to an embodiment of the present disclosure;

FIGS. 10A, 10B, 10C, 10D, 10E, and 10F illustrate a mobile device configured to manage a push message according to an embodiment of the present disclosure;

FIG. 11 is a flowchart illustrating a method for managing messages according to an embodiment of the present disclosure;

FIG. 12 is a computing environment implementing a method and a mobile device thereof for managing push messages according to an embodiment of the present disclosure; and

FIG. 13 is a flowchart illustrating a control method of an electronic apparatus according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Various embodiments of the present disclosure described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the various embodiments herein can be practiced and to further enable those skilled in the art to practice the various embodiments herein. Accordingly, the examples should not be construed as limiting the scope of the various embodiments herein.

As is traditional in the field, various embodiments may be described and illustrated in terms of blocks which carry out a described function or functions. These blocks, which may be referred to herein as units or modules or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

Prior to describing the various embodiments in detail, it is useful to provide definitions for key terms used herein. Unless defined otherwise, all technical terms used herein have the same meaning as commonly understood by a person having ordinary skill in the art to which this disclosure belongs.

A push notification (i.e., a push message) includes a message that is pushed from backend server or application to user interface (UI). The push notification may pop up a message in front of application's user information, along with the alert sounds. The push notification may include images and hypertext link. The push notification may be displayed in a notification panel. The notification panel may be a place to quickly access alerts, notification and shortcuts on a display of an electronic apparatus. The notification panel may be at the top of a screen of the electronic apparatus. It may be hidden in the screen but can be accessed by swiping a finger of a user from the top of the screen to the bottom. It may be accessible from any menu or application.

Push notification manager is an element and/or module (for example, chipset, hardware component, electronic circuit, electrical circuit, electronic circuit embedded with instructions, and the like) used for controlling at least one functionality associated with a push message described herein.

Accordingly, the various embodiments herein provide a method for managing a push message by a mobile device. The method includes displaying, by a push notification manager, the push message associated with a content provider in a notification area of the mobile device, wherein the push message comprises the content and at least one interactive graphical element. Further, the method includes detecting, by the push notification manager, a gesture performed on the at least one interactive graphical element of the push message displayed in the notification area. Furthermore, the method includes performing, by the push notification manager, at least one action within the notification area based on the gesture.

In an embodiment of the present disclosure, the action is performed within the notification area without launching an application associated with the content provider.

In an embodiment of the present disclosure, the action comprises at least one of making payment, playing a media file, displaying directions to a location using maps, adding details of an event in an application, scrolling the content and changing the push message.

In an embodiment of the present disclosure, an output of the action is displayed within a graphical representation of the push message.

In an embodiment of the present disclosure, the push message is customized to include the at least one interactive graphical element by at least one of the mobile device, a gateway server, and the content provider.

In an embodiment of the present disclosure, the push message further includes at least one of a layout structure comprising the at least one interactive graphical element, a push card framework details, a registered identifier of the push message, a cross application interfacing service, and at least one action information facilitating to perform within the notification area without launching one of an application associated with the content provider and a browser application.

In an embodiment of the present disclosure, the at least one interactive graphical element is defined based on at least one of content of the push message, application profile and application theme.

Accordingly, the various embodiments herein provide yet another method for managing a push message by a mobile device, the method includes displaying by a push notification manager the push message associated with a content provider in a notification area of the mobile device, wherein the push message comprises a content and at least one interactive graphical element to perform at least one action within the notification area.

Accordingly, the various embodiments herein provide yet another method for a message displayed within a web page by a web browser in a mobile device. The method includes displaying the message associated with a content provider in a specific area of the web page, wherein the message comprises a content and at least one interactive graphical element, detecting a gesture performed on the at least one interactive graphical element of the message displayed in the specified area of the web page, and performing at least one action within the specified area of the web page based on the gesture.

Accordingly, the various embodiments herein provide an apparatus for managing a push message, the apparatus comprises a push notification manager configured to customize the push message to include content and at least one interactive graphical element to perform at least one action within a notification area of a mobile device and transmit the customized push message to the mobile device.

Accordingly, the various embodiments herein provide a mobile device for managing a push message. The mobile device comprises a push notification manager configured to: display the push message associated with a content provider in a notification area of the mobile device, wherein the push message comprises the content and at least one interactive graphical element, detect a gesture performed on the at least one interactive graphical element of the push message displayed in the notification area and perform at least one action within the notification area based on the gesture.

Accordingly, the various embodiments herein provide a mobile device for managing a push message. The mobile device comprises a push notification manager configured to display the push message associated with a content provider in a notification area of the mobile device, wherein the push message comprises content and at least one interactive graphical element to perform at least one action within the notification area.

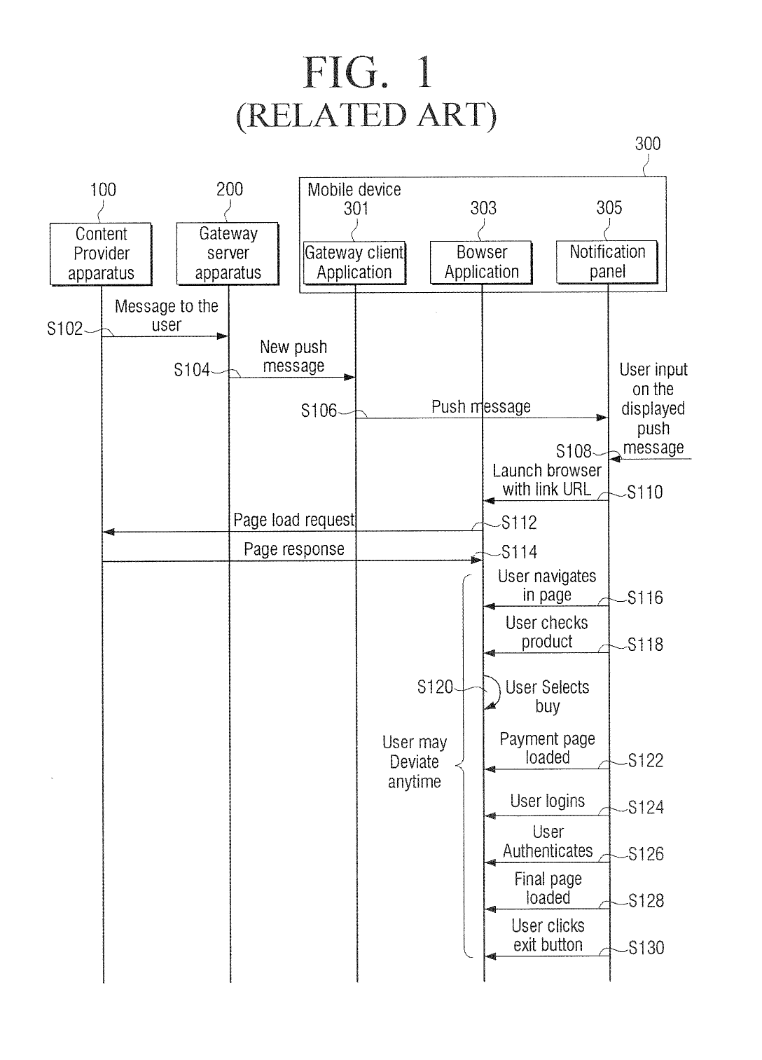

FIG. 1 is a sequence diagram illustrating a method for managing a push message in which a user accesses a content of the push message in a browser application according to the related art.

Referring to FIG. 1, a content provider apparatus 100 transmits a push message (i.e., the message comprising details of a product/content) to a mobile device 300 in operation S102. A gateway server apparatus 200 may receive the message from the content provider apparatus 100 and may transmit a new push message in operation S104, from an instruction stored therein, to a gateway client application 301 of the mobile device 300, where the new push message comprises the content therein. A gateway client application 301 may notify a user of the mobile device 300 by way of transmitting a push message to a notification panel 305 of the mobile device 300 in operation S106, where the push message comprises the new push message. The notification panel 305 may therefore cause the mobile device 300 to display the push message comprising the new push message therein.

Once the notification panel 305 detects a user input in operation S108, the notification panel 305 may thereupon launch a browser application 303 in operation S110 (or, the native application) with link uniform resource locator (URL) corresponding to the content (i.e., a new push message). The browser application 303 may request for the content page (i.e., a webpage) from the content provider apparatus 100 in operation S112. The content provider apparatus 100 may transmit a page response to the browser application 303 in operation S114.

Once the page (for example, webpage(s) of the content) is launched, the user may navigate into the pages (for example, web pages) of the push message in operation S116 to buy and/or view (or review) the product. Further, the user checks the details of the product in operation S118, and may select buy in operation S120, by performing a gesture on one of the action element associated with the webpage of the browser application 303 currently rendered, option to buy the product. As a result, the payment page is loaded in operation S122, the user logins with the content provider apparatus 100 in operation S124, authenticates in operation S126 (while making the payment) and receives an acknowledgement/failure page providing the status of the product in operation S128. In operation S128, the user may click exit option (or, button) associated with the webpage of the browser application 303 to exit the push message provided received from the content provider apparatus 100.

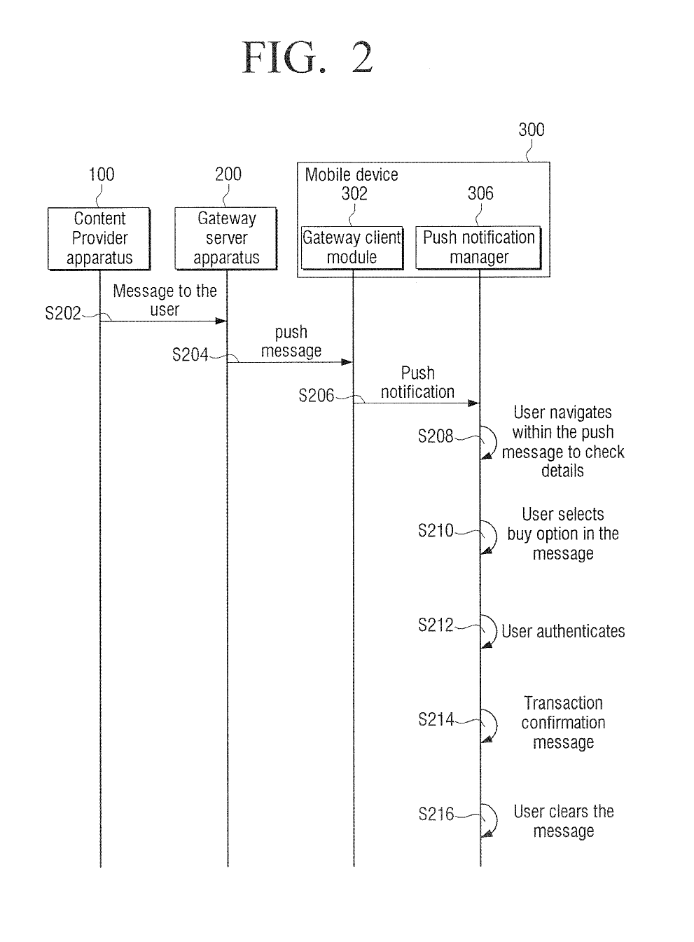

FIG. 2 is a sequence diagram illustrating a method for managing a push message in which a user accesses content of the push message in a notification area of a mobile device according to an embodiment of the present disclosure.

The present disclosure may allow the user of the mobile device 300 to circumvent the cumbersome process involved while performing the action (for e.g., purchasing, reviewing, navigating) related to the product and/or content of the push message, as detailed in FIG. 2.

Referring to FIG. 2, a content provider apparatus 100 transmits a message (i.e., the message comprising details of a product/content) to the user of a mobile device 300 in operation S202. The push message may pass through a gateway server apparatus 200. The gateway server apparatus 200 then transmits a message (i.e., a push message) to a gateway client module 302 of the mobile device 300 in operation S204. The gateway client module 302 may validate a push message (i.e., the push message notified by the gateway server apparatus 200), and thereafter transmits the push message to a push notification manager 306 of the mobile device 300 in operation S206.

The push notification manager 306 may display the push message in a notification area of the mobile device 300. The user may perform the following operations in the push message within the notification area of the mobile device 300, operations, such as navigating within the push message to check details of the product in operation S208, selecting buy option (interactive graphical element) in the push message in operation S210, authenticating (i.e., by any known authentication mechanism, for example, fingerprint based authentication) the product details and payment details in operation S212. Further, the push notification manager 306 provides transaction confirmation message within the notification area in operation S214, and thereby the user upon confirmation of the transaction clears the push message in operation S216.

Therefore, the present disclosure can provide the user to perform the one or more actions related to the product associated with the push message in the notification area itself, without launching one of the application associated with the content, and a browser application 303 described in FIG. 1.

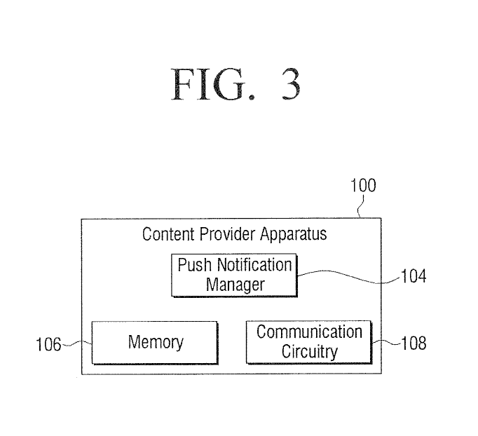

FIG. 3 illustrates blocks of a content provider apparatus for managing a push message according to an embodiment of the present disclosure.

Referring to FIG. 3, in an embodiment of the present disclosure, the content provider apparatus 100 may be, for example, an electronic device, a wearable device, a laptop computer, a tablet, a mobile device internet of things (IoT), or any consumer electronic devices. The content provider apparatus 100 may also include, for example, the electronic device or server capable of selling the product over a network/internet.

The content provider apparatus 100 comprises a push notification manager 104, a memory 106, and a communication circuitry 108.

The push notification manager 104 is configured to customize the push message to include content and at least one interactive graphical element to perform the at least one action within the notification area of the mobile device 300. Further, the push notification manager 104 is configured to transmit the customized push message to the mobile device 300.

The memory 106 may store various programs and data necessary for the operation of the content provider apparatus 100. At least one processor (not illustrated) may control the overall operation of the content provider apparatus 100 using the various programs stored in the memory 106. The memory 106 may be accessed by the at least one processor, and the at least one processor may read/record/correct/delete/update data with respect to the memory 106. The memory 106 in this disclosure may include a read only memory (ROM) or a random access memory (RAM) in the at least one processor, or a memory card mounted in the content provider apparatus 100.

The communication circuitry 108 may communicate with electronic apparatuses and other servers. The communication circuitry 108 may include at least one of a Wi-Fi chip (not shown), a bluetooth (BT) chip (not shown), a wireless communication chip (not shown), and a near field communication (NFC) chip (not shown).

More particularly, the Wi-Fi chip (not shown) and the BT chip (not shown) may perform communication in a Wi-Fi method (i.e., according to an institute of electrical and electronics engineers (IEEE) 802.11 standard for wireless communication) and a BT method, respectively. The wireless communication chip (not shown) may be a chip which performs communication according to various communication standards, such as IEEE, ZigBee, long term evolution (LTE), and the like.

The action is performed within the notification area without launching an application associated with the content provider. The output of the action is displayed within a graphical representation of the push message. For example, the action may include various kind of action corresponding to the push message, such as making payment, playing a media file, displaying directions to location using maps, adding details of an event in an application, scrolling the content and changing the push message.

FIG. 3 shows a limited overview of the content provider apparatus 100 but, it is to be understood that other embodiments are not limited thereto. Further, the content provider apparatus 100 can include any number of units along with other hardware or software components communicating with each other. For example, the component can be, but not limited to, a process running in the controller or processor, an object, an executable process, a thread of execution, a program, or a computer. By way of illustration, both an application running on a device and the device itself can be a component.

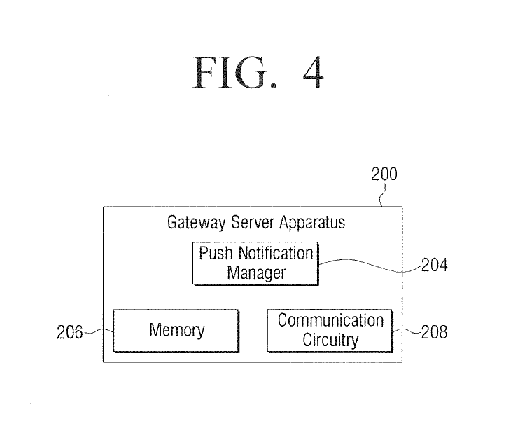

FIG. 4 illustrates blocks of a gateway server apparatus for managing a push message according to an embodiment of the present disclosure.

In an embodiment of the present disclosure, the gateway server apparatus 200 may be, for example, an electronic device, a wearable device, a tablet, a mobile device IoT, or any consumer electronic devices. The gateway server apparatus 200 may also include, for example, the server (for example, a gateway server, a gateway proxy server, a push server, a content provider clouding managing server, push provider server, and the like).

Referring to FIG. 4, the gateway server apparatus 200 comprises a push notification manager 204, a memory 206, and a communication circuitry 208.

The push notification manager 204 is configured to customize the push message to include content and at least one interactive graphical element to perform the at least one action within the notification area of the mobile device 300. Further, the push notification manager 204 is configured to transmit the customized push message to the mobile device 300.

The action is performed within the notification area without launching an application associated with the content provider. The action herein may include, for example, (a) making an online payment via a payment mechanism, (b) playing a media file, (c) displaying directions to a location using a maps application and (d) adding details of an event in a planner application. The output of the action is displayed within a graphical representation of the push message.

The at least one interactive graphical element is defined based on the at least one of content of the push message, application profile, and application theme.

The memory 206 may store various programs and data necessary for the operation of the gateway server apparatus 200. At least one processor (not illustrated) may control the overall operation of the gateway server apparatus 200 using the various programs stored in the memory 206. The memory 206 may be accessed by the at least one processor, and the at least one processor may read/record/correct/delete/update data with respect to the memory 206. The memory 206 in this disclosure may include a ROM or a RAM in the at least one processor, or a memory card mounted in the gateway server apparatus 200.

The communication circuitry 208 may communicate with electronic apparatuses and other servers. The communication circuitry 208 may include at least one of a Wi-Fi chip (not shown), a BT chip (not shown), a wireless communication chip (not shown), and a NFC chip (not shown).

More particularly, the Wi-Fi chip (not shown) and the BT chip (not shown) may perform communication in a Wi-Fi method (i.e., according to an IEEE 802.11 standard for wireless communication) and a BT method, respectively. The wireless communication chip (not shown) may be a chip which performs communication according to various communication standards, such as IEEE, ZigBee, LTE, and the like.

FIG. 4 shows a limited overview of the gateway server apparatus 200 but, it is to be understood that other embodiments are not limited thereto. Further, the gateway server apparatus 200 can include any number of units along with other hardware or software components communicating with each other. For example, the component can be, but not limited to, a process running in the controller or processor, an object, an executable process, a thread of execution, a program, or a computer. By way of illustration, both an application running on a device and the device itself can be a component.

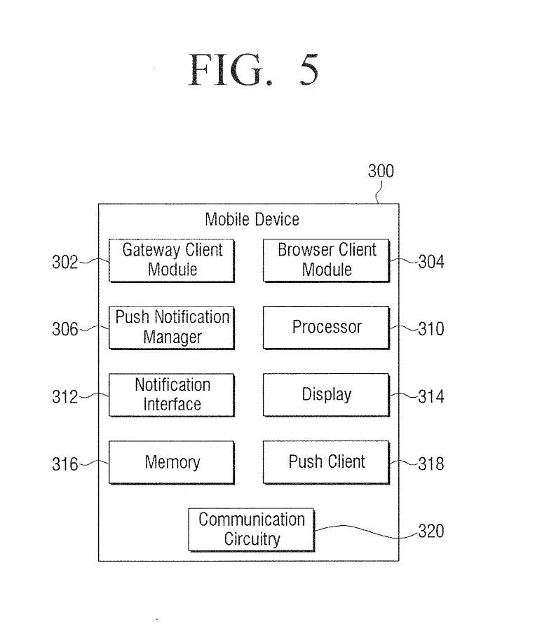

FIG. 5 illustrates bocks of a mobile device for managing a push message according to an embodiment of the present disclosure.

Referring to FIG. 5, the mobile device 300 may be, for example, an electronic device (apparatus), a wearable device, a laptop computer, a desktop computer, a smart television (TV), a smart display, a notebook computer, a notebook, a tablet, a mobile phone, IoT, other forms of data processing device are within the scope of the various embodiments discussed herein.

The mobile device 300 includes a gateway client module 302, a browser client module 304, a push notification manager 306, a processor 310 (for example; a hardware unit, an apparatus, a central processing unit (CPU), a graphics processing unit (GPU)) communicatively coupled to a push notification manager 306, a notification interface 312 communicatively coupled to a display 314 (e.g., a cathode ray tube (CRT) display, a liquid crystal display (LCD)), a light-emitting diode (LED) being interfaced with the processor 310, a memory 316 (e.g., a volatile memory and/or a non-volatile memory) communicatively coupled to the processor 310, a push client 318, and a communication circuitry 320. The memory 316 includes storage locations configured to be addressable through the processor 310.

For example, the gateway client module 302 may validate a push message (i.e., the push message notified by the gateway server apparatus 200 or the push message notified by push provider apparatus 200), and transmit the push message to the push notification manager 306.

For another example, the gateway client module 302 connected (through means of any instructions stored therein) to a browser client module 304 may transmit the feedback messages directly to the content provider apparatus 100. Here, the gateway client module 302 may only validate the push message from the content provider apparatus 100.

The browser client module 304 may receive the push message, validate and transmit to the gateway client module 302. The gateway client module 302 may download the image resources required for basic display and extended navigation and add the content based options. The gateway client module 302 adds the custom options as configured by the user for various content type. The gateway client module 302 may make the notification compatible builder and notifies to push notification manager 306 in the notification area.

In another example, the gateway client module 302 running on the browser client module 304 may constantly poll the content provider apparatus 100 when the content provider apparatus 100 directly transmits the push message to the mobile device 300. Then, the gateway client module 302 may take care of feedback, such as payment.

The push notification manager 306 configured to display the push message associated with a content provider in the notification interface 312 of the mobile device 300, where the push message comprises the content and the at least one interactive graphical element.

The notification interface 312 may include, for example, the notification area of the display 314, where the user may interact and/or view the push message. The notification area may include, for example, notification bar, notification tray, notification area when a screen of the display 314 is locked, predefined notification area in an edge display, wearable device, or any other area of the display 314 where the user may receive the notifications (i.e., a push message). The notification interface 312 comprises a notification area and a plurality of push message areas within the notification area. The notification interface 312 may is displayed on at least one area on the display 314.

The at least one interactive graphical element may include, for example, a UI element, an icon, a button, a left arrow, a right arrow, scrolling button to scroll up/down, graphical symbol, and the like. The UI element in response to the user gesture input may configured to trigger a function associated therewith (for example, buying the product).

Further, the push notification manager 306 may detect a gesture performed on the at least one interactive graphical element of the push message displayed in the notification area of the display 314. The gesture may include, for example, a touch, force-input, wave gesture, and the like.

Furthermore, the push notification manager 306 may perform the at least one action within the notification area based on the gesture detected by the display 314 communicatively coupled to the processor 310 and push notification manager 306. The at least one action may include, for example, navigating within the pages of the push message based on the gesture input detected on the at least one interactive graphical element (i.e., a scrolling button, a review button, a buy now button, and the like) present in the push message. Further, the action may include buying the product by clicking (gesture performed by the user) onto the buy button (interactive graphical element).

Further, the action herein may include, for example, (a) making an online payment via a payment mechanism, (b) playing a media file (for example, playing movie/song when a media file has been received by the media file provider, the media file may include at least one interactive element, such as play/pause), (c) displaying directions to a location using a maps application, and (d) adding details of an event in a planner application. The output of the action is displayed within a graphical representation of the push message.

The action is performed within the notification area without launching the application associated with the content provider. The output of the action is displayed within a graphical representation of the push notification. The graphical representation of the push notification may include, for example, tab/window in which the push message is currently displayed.

In another embodiment of the present disclosure, the push notification manger 306 may display the push message associated with the content provider apparatus 100 in the notification interface 312 (i.e., the notification area) of the mobile device 300, wherein the push message includes the content and the at least one interactive graphical element to perform the at least one action within the notification interface 312.

The memory 316 may include one or more computer-readable storage media. The memory 316 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 316 may, in some examples, be considered a non-transitory storage medium. The term “non-transitory” may indicate that the storage medium is not embodied in a carrier wave or a propagated signal. However, the term “non-transitory” should not be interpreted that the memory 316 is non-movable. In some examples, the memory 316 can be configured to store larger amounts of information than the memory. In certain examples, a non-transitory storage medium may store data that can, over time, change (e.g., in RAM or cache).

The memory 316 may store one or more programs and data necessary for the operation of the mobile device 300. At least one processor 310 may control the overall operation of the mobile device 300 using the various (one or more) programs stored in the memory 316. The memory 316 may be accessed by the at least one processor 310, and the at least one processor 310 may read/record/correct/delete/update data with respect to the memory 316.

One or more computer programs may include an instruction to, in response to receiving a notification message regarding a content from an external server, control the display 314 to display a notification message including an image of a content provided from an external server and a UI element regarding the content in an area within a notification area and an instruction to control the display 314 to display a graphic UI (GUI) corresponding to the operation on the notification message.

One or more computer programs may include an instruction to control the display to display a GUI corresponding to the operation in an area other than the UI element on the notification message.

The UI element may include at least one of an icon for payment of the content and an icon for review of the content.

One or more computer programs may include an instruction to control the display 314 to, in response to an icon for payment of the content being selected, display an object representing a payment method (for example, credit card, mobile card, virtual currency, and the like) stored in the memory 316 of the electronic apparatus received from another external server on the notification message.

One or more computer programs may, in response to a personal authentication input for the payment being received by a user in a state in which the object is displayed, include an instruction to identify whether the personal authentication input matches with personal authentication information stored in the memory 316 of the electronic apparatus 300, and in response to identifying that the personal authentication input matches with the personal authentication information stored in the memory 316 of the electronic apparatus 300, include an instruction the display 314 to remove the object and display purchase completion information of content in an area in which the notification message is displayed.

For example, the personal authentication input may include at least one of fingerprint recognition, iris recognition, voice recognition, security key input of the user, but the example is not limited thereto.

One or more computer programs may include an instruction to control the display 314 to display a navigation icon on a notification message and an instruction to control the display 314 to display another notification message in a notification area when the navigation icon is selected by the user. For example, the navigation icon may be an arrow for the electronic apparatus 300 to search for history of notification messages displayed on the display 314.

In addition, a notification message may include at least another UI element including information capable of changing or setting an option of the notification message. For example, another UI element may include icons, such as ‘share’ for transmitting a notification message to another person, ‘setting’ for changing a background color of a notification message, and the like, but the example is not limited thereto.

The push client 318 may receive a push message from push server connected to the gateway server apparatus 200 or the push provider server apparatus 200. The push client 318 may transmit the received push message to push notification manager 306.

The communication circuitry 320 communicates internally with the units and externally with networks. The communication circuitry 320 may include at least one of a Wi-Fi chip (not shown), a BT chip (not shown), a wireless communication chip (not shown), and a NFC chip (not shown).

More particularly, the Wi-Fi chip (not shown) and the BT chip (not shown) may perform communication in a Wi-Fi method (i.e., according to an IEEE 802.11 standard for wireless communication) and a BT method, respectively. The wireless communication chip (not shown) may be a chip which performs communication according to various communication standards, such as IEEE, ZigBee, LTE, and the like.

FIG. 5 shows a limited overview of the mobile device 300 but, it is to be understood that other embodiments are not limited thereto. Further, the mobile device 300 can include any number of units along with other hardware or software components communicating with each other. For example, the component can be, but not limited to, a process running in the controller or processor, an object, an executable process, a thread of execution, a program, or a computer. By way of illustration, both an application running on a device and the device itself can be a component.

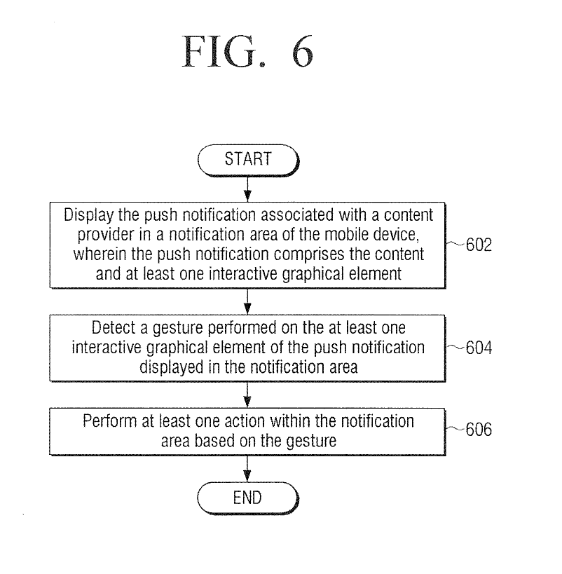

FIG. 6 is a flowchart illustrating a method for managing a push message by a mobile device according to an embodiment of the present disclosure.

Referring to FIG. 6, at operation 602, the mobile device 300 displays the push notification associated with the content provider in the notification interface 312 of the mobile device 300, wherein the push message comprises the content and the at least one interactive graphical element. For example, in the mobile device 300, as illustrated in FIG. 5, the push notification manger 306 displays the push notification associated with the content provider in the notification interface 312 of the mobile device 300, wherein the push message comprises the content and the at least one interactive graphical element.

Further, at operation 604, the mobile device 300 detects the gesture performed on the at least one interactive graphical element of the push message displayed in the notification interface 312. For example, in the mobile device 300, as illustrated in FIG. 5, the push notification manger 306 may detect the gesture performed on the at least one interactive graphical element of the push message displayed in the notification interface 312.

Further, at operation 606, the mobile device 300 perform the at least one action within the notification area based on the gesture. For example, in the mobile device 300, as illustrated in FIG. 5, the push notification manger 306 may perform the at least one action within the notification area based on the gesture.

The various actions, acts, blocks, operations, or the like in the flowchart may be performed in the order presented, in a different order or simultaneously. Further, in some embodiments of the present disclosure, some of the actions, acts, blocks, operations, or the like may be omitted, added, modified, skipped, or the like without departing from the scope of the disclosure.

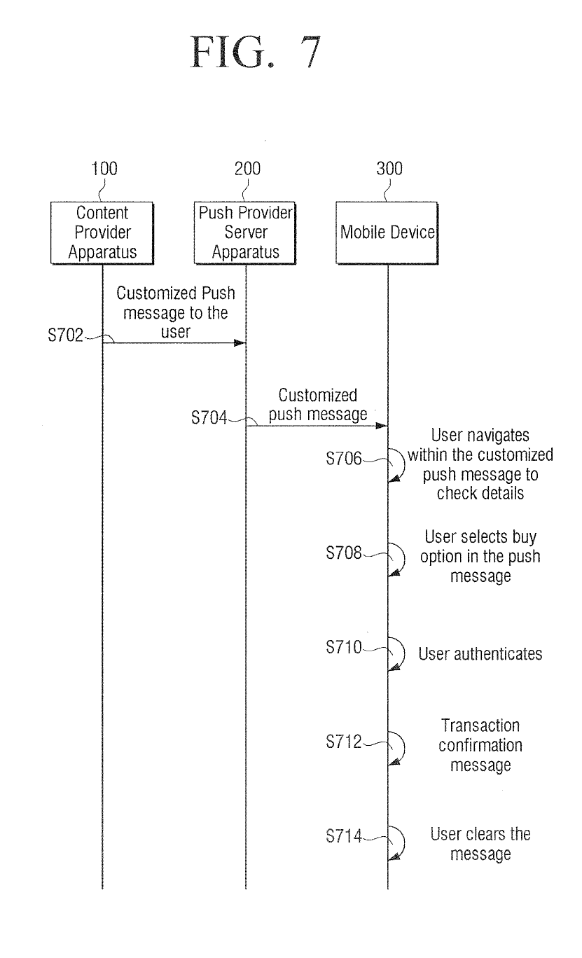

FIG. 7 is a sequence diagram illustrating a method in which a push message is customized by a content provider apparatus according to an embodiment of the present disclosure.

The content provider apparatus 100 may directly transmit the push message to the Push Provider server apparatus 200 (for example, cloud messaging server). The gateway client module 302 connected (through means of any instructions stored therein) to a browser client module 304 in the mobile device 300 may transmit the feedback messages directly to the content provider apparatus 100 instead of passing through the gateway server apparatus 200 (i.e., gateway server proxy). The gateway client module 302 may only validate the push message from the content provider apparatus 100.

Referring to FIG. 7, the content provider apparatus 100 transmits a customized push message to the push provider server apparatus 200 in operation S702. The customized push message may include the content and the at least one interactive graphical element to perform the at least one action within the notification area of the mobile device 300. The push provider server apparatus 200 then transmits the customized push message to the mobile device 300 in operation S704.

Once the mobile device 300 receives the customized push message, the push notification manager 306 may display the customized push message in the notification area of the display 314. The user may perform the following operations in the push message within the notification area of the mobile device 300, operations, such as navigating within the push message to check details of the product in operation S706, selecting buy option (interactive graphical element) in the push message in operation S708, authenticating (i.e., any known authentication mechanism, for example, fingerprint based authentication) the product details and payment details in operation S710. Further, the push notification manager 306 provides transaction confirmation message within the notification area in operation S712, and thereby the user upon confirmation of the transaction clears the push message in operation S714.

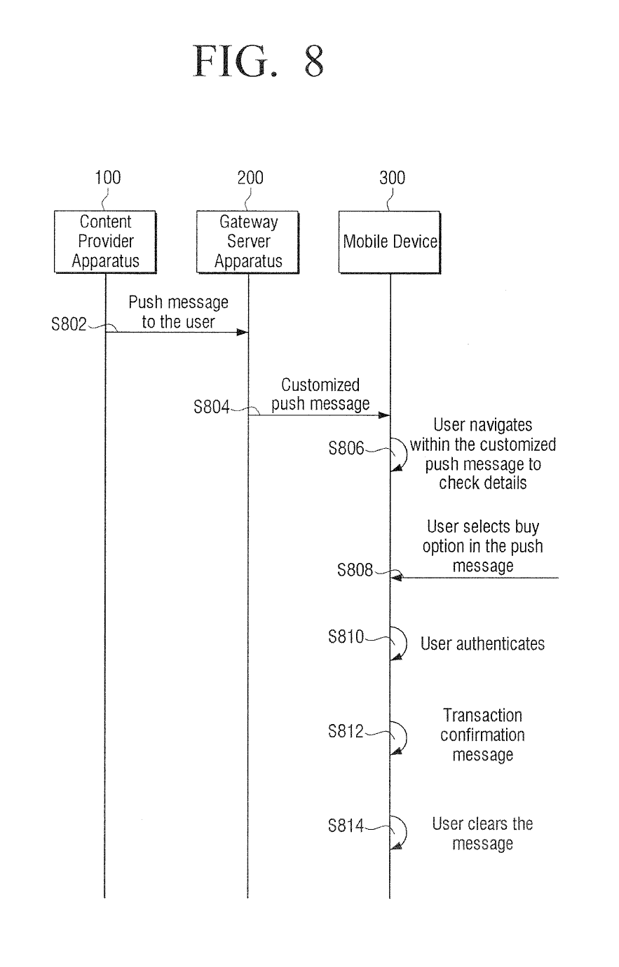

FIG. 8 is a sequence diagram illustrating a method in which the push message is customized by the gateway server apparatus according to an embodiment of the present disclosure. There is a proxy called gateway server between the content provider apparatus 100 and the mobile device 300. The mobile device 300 may transmit the feedback messages via the gateway server apparatus 200 to the content provider apparatus 100. The gateway server apparatus 200 also validates the push notifications from the premium content providers.

Referring to FIG. 8, the content provider apparatus 100 transmits the push message to the gateway server apparatus 200 in operation S802. The gateway server apparatus 200 may customize the push message by using of two approaches described below:

Approach-1 (option-1): the content provider apparatus 100 transmits the push message filling the new fields, the gateway server apparatus 200 verifies the new fields and requests content provider apparatus 100 for missing fields, the gateway server apparatus 200 strips the push message to basic format if the message is not from the content provider apparatus 100. Further, gateway server apparatus 200 adds registered identification (REG ID) and transmits to a push server. The push server may then transmit to the push client 318 on the mobile device 300. For example, push server may push a resource directly to the client without the client asking for the resource.

Approach-1 (option-2): the content provider apparatus 100 may transmit the push message with basic fields, the gateway server apparatus 200 converts it into a push card message by using product review data from third party sources. Further, the gateway server apparatus 200 adds REG ID and transmits the push message to a push server. The push server may then transmit to the push client 318 on the mobile device 300.

Approach-2: the content provider apparatus 100 may transmit the push message in compliance with the world wide web consortium push application program interface (W3C Push application programming interface (API)), the gateway server apparatus 200 adds REG ID and transmits to a push server, and the push server may then transmit to the push client 318 on the mobile device 300.

The customized push message may include the content and the at least one interactive graphical element to perform the at least one action within the notification area of the mobile device 300. The gateway server apparatus 200 then transmits the customized push message to the mobile device 300 in operation S804. The mobile device 300 can manage the customized push message in one of an offline mode and an online mode, as detailed below:

Offline Mode: the bowser client module 304 of the mobile device 300 receives the push message, validates and transmits to the gateway client module 302 of the mobile device 300. The gateway client module 302 may download the image resources required for basic display and extended navigation and adds the content based options. For example, depending on the content the interactive graphical element may be added into the push message.

Furthermore, the gateway client module 302 adds the custom options as configured by the user for various content type. For example, Tag it for only live messages, Archive for only Ecommerce messages to keep the deal codes secure, and the like. Thus, the push notification manager 306 brings the necessary cross application on demand services as suggested by the layout type. For example, custom layouts include pay layouts, music player service for audio layouts, maps service for tracking map layouts, planner service for calendar layouts, and the like.

The gateway client module 302 makes the notification compatible builder and notifies to push notification manager 306 in the notification area, as all the content is available and activity names are given for each interactive graphical element.

Online Mode: the browser client module 304 of the mobile device 300 receives the push message, validates and transmits to the gateway client module 302 of the mobile device 300. The gateway client module 302 may download the image resources required for basic display. For example, depending on the content the interactive graphical element may be added into the push message.

Furthermore, the gateway client module 302 adds the custom options as configured by the user for various content type. For example, Tag it for only live messages, Archive for only Ecommerce messages to keep the deal codes secure, and the like. Thus, the push notification manager 306 brings the necessary cross application on demand services as suggested by the layout type. For example, custom layouts include pay layouts, music player service for audio layouts, maps service for tracking map layouts, planner service for calendar layouts, and the like. These custom layouts download the preview, extended options related images based on user actions.

The gateway client module 302 makes the notification compatible builder and notifies to push notification manager 306 in the notification area, as all the content is available and activity names are given for each interactive graphical element.

Once the mobile device 300 receives the customized push message, the push notification manager 306 may display the customized push message in the notification area of the display 314. The user may perform the following operations in the push message within the notification area of the mobile device 300, operations, such as navigating within the push message to check details of the product in operation S806, selecting buy option (interactive graphical element) in the push message in operation S808, authenticating (i.e., any known authentication mechanism, for example, fingerprint based authentication) the product details and payment details in operation S810. Further, the push notification manager 306 provides transaction confirmation message within the notification area in operation S812, and thereby the user upon confirmation of the transaction clears the push message in operation S814.

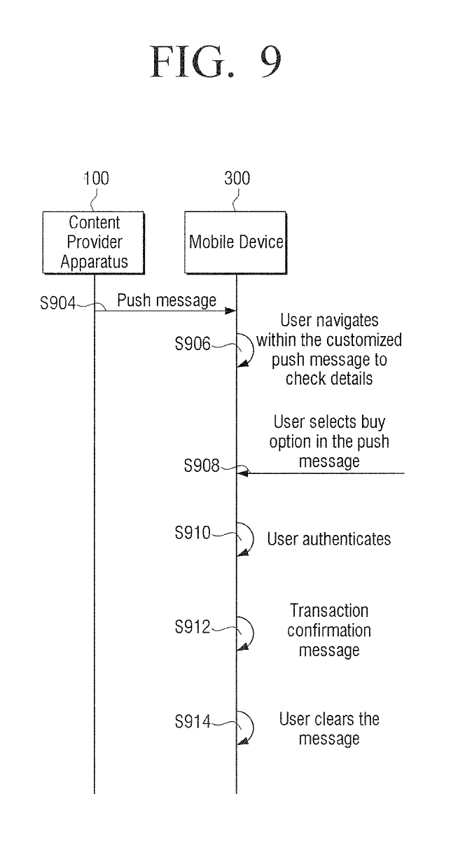

FIG. 9 is a sequence diagram illustrating a method in which the push message is customized by the mobile device according to an embodiment of the present disclosure. The gateway client module 302 running on the browser client module 304 in the mobile device 300 constantly polls the content provider apparatus 100. The content provider apparatus 100 may directly transmit the push message to the mobile device 300. The gateway client module 302 in the mobile device 300 takes care of feedback, payment, and the like.

Referring to FIG. 9, the content provider apparatus 100 transmits a push message to the mobile device 300 in operation S904.

Once the mobile device 300 receives the push message, the push notification manager 306 may customize the push message to include the at least one interactive graphical element along with the content. Further, the push notification manager 306 may display the customized push message in the notification area of the display 314. The user may perform the following operations in the push message within the notification area of the mobile device 300, operations, such as navigating within the push message to check details of the product in operation S906, selecting buy option (interactive graphical element) in the push message in operation S908, authenticating (i.e., any known authentication mechanism, for example, fingerprint based authentication) the product details and payment details in operation S910. Further, the push notification manager 306 provides transaction confirmation message within the notification area in operation S912, and thereby the user upon confirmation of the transaction clears the push message in operation S914.

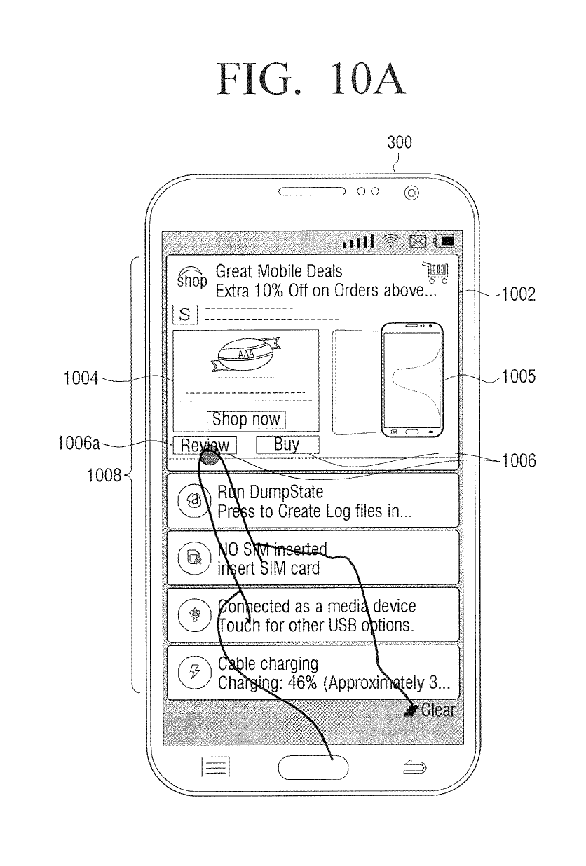

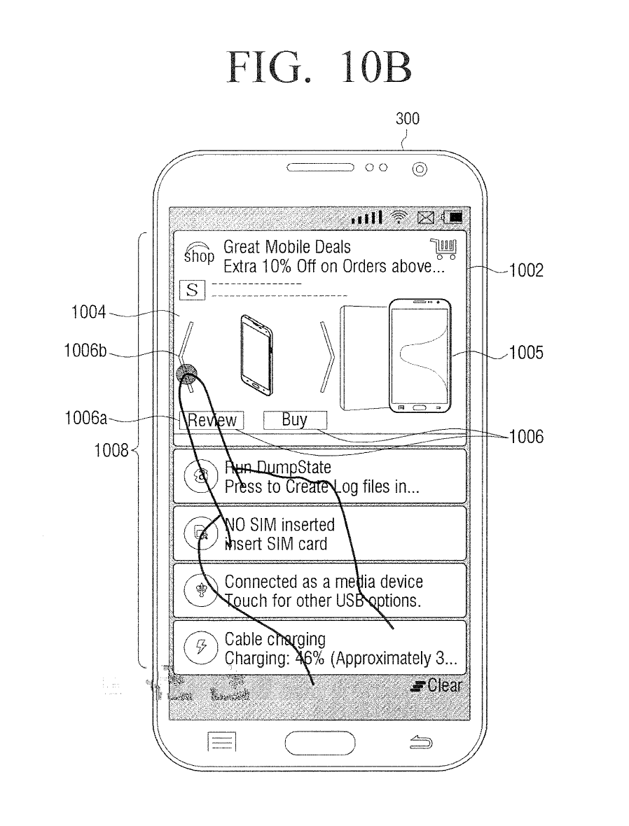

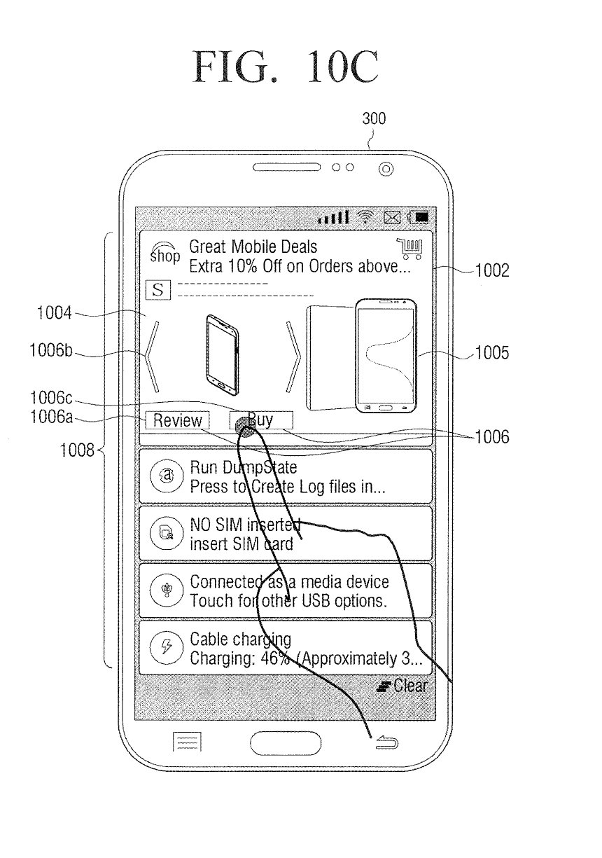

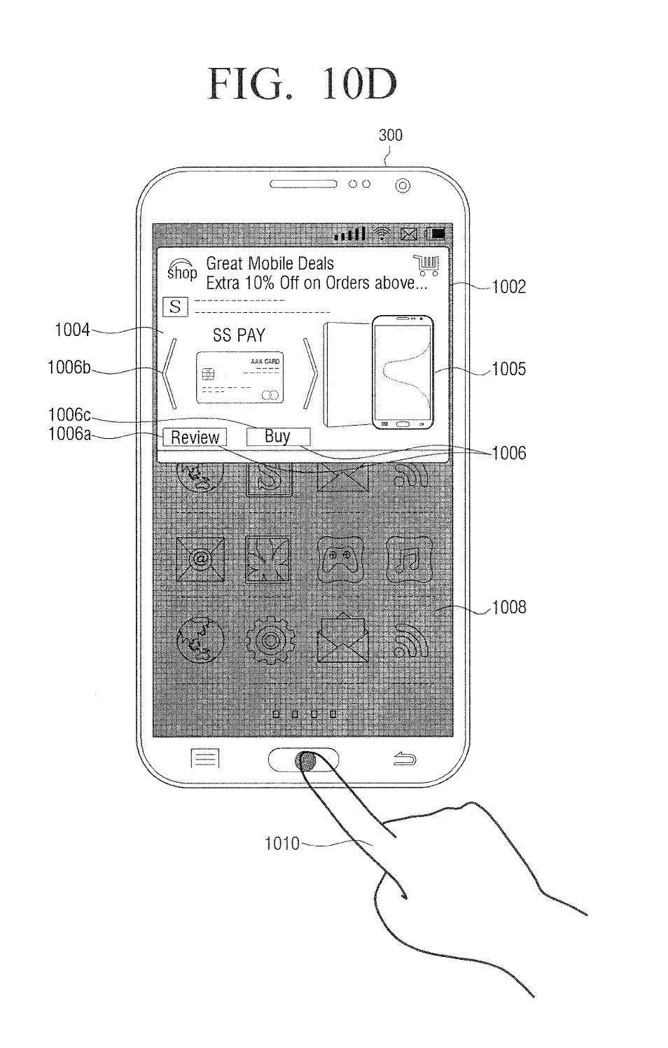

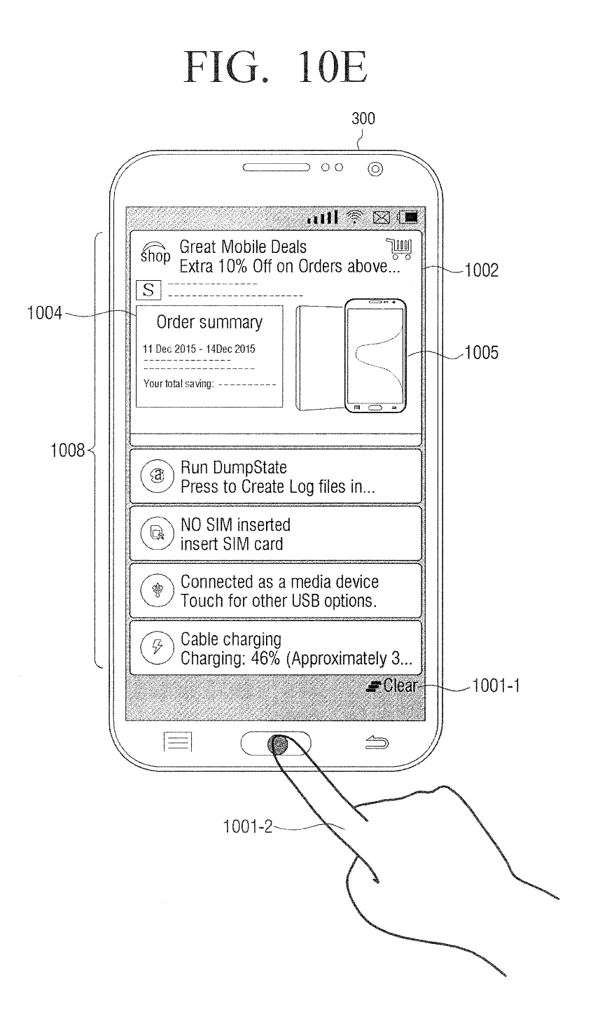

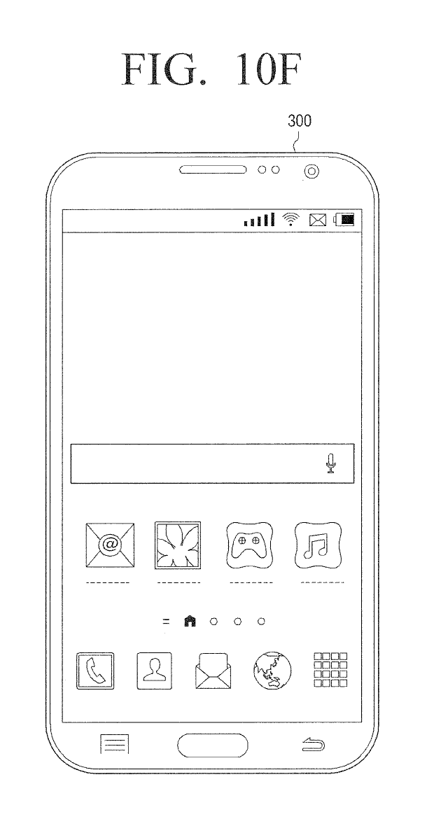

FIGS. 10A, 10B, 10C, 10D, 10E, and 10F illustrate a mobile device configured to manage a push message according to an embodiment of the present disclosure.

Referring to FIG. 10A, the user may receive a notification message 1002 from an external server (e.g., content provider apparatus, push server apparatus, gateway server apparatus) in the notification area 1008 of the mobile device 300. The notification message 1002 may include a content 1005 and the at least one interactive graphical element 1006 (i.e., a UI element). The user may perform a gesture 1010 on the at least one interactive graphical element 1006 of the notification message 1002. The user may perform an action (to review the content detail) thereto may click on the review button (e.g., an interactive graphical element 1006a), thus the action may be triggered within a graphical element 1004 of the notification message 1002 displayed on the notification area 1008. The action may be triggered within the graphical element 1004 which is extended area including content 1005 area.

Further, referring to FIG. 10B, the user while reviewing the details of the content may wish to scroll the page (left/right) or may wish to navigate to another push message (i.e., previously viewed or next). Thus, the user may perform an action thereto may click on the left arrow button (e.g., a graphical element 1006b), thus the action may be triggered within the graphical element 1004 of the notification message 1002 displayed on the notification area 1008.

Furthermore, referring to FIG. 10C, the user post reviewing the details of the content may wish to buy the product. Thus, the user may perform an action thereto may click on the pay button (e.g., a buy button) (e.g., a graphical element 1006c), thus the action may be triggered within the graphical element 1004 of the notification message 1002 displayed on the notification area 1008. The action may be triggered within the graphical element 1004 which is extended area including content 1005 area.

Furthermore, referring to FIG. 10D, the user navigates to the payment page within the graphical element 1004 of the notification message 1002 displayed on the notification area 1008. The user may perform an action (e.g., the gesture 1010) (to authenticate the details of the payment and the product) by way of an authentication mechanism (for ex., fingerprint, or any other known authentication mechanism). The action may be triggered within the graphical element 1004 which is extended area including content 1005 area.

Referring to FIGS. 10E and 10F, the user may exit or clear the notification area 1008 by clicking a clear icon 1001-1 or a home button 1001-2 after the transaction confirmation as illustrated in FIGS. 10E and 10F.

According to the present disclosure, the user of the mobile device 300 may purchase products directly from the notification interface 312 (i.e., the notification area 1008) without using short message service (SMS) reminders. A user receives a web push message containing cart deals and browser displays it in the notification interface 312. Further, the user selects ‘Review’ option to check the cart details. The user verified the cart details and selected ‘Pay’ option to make payment. Further, the user is authenticated using wallet application with his finger print and transaction success details are shown to the user. Further, the user can press home button to get back to the home screen.

In another example scenario, the method includes navigating to previous push messages directly from notification interface 312. The proposed method enables the navigation of push messages using a navigation arrows (as detailed in FIG. 10B) enables push history. Therefore, the user of the mobile device 300 may navigate push histories through previous push message directly from the notification area 1008. In addition, the mobile device 300 may navigate of web push messages both for online and offline.

Unlike the existing method, where once the mobile device 300 restarts all the push messages are gone and are not available to user further, the proposed method can allow the user to navigate into the web push messages even when there is no internet connectivity (i.e., offline web applications).

In another example scenario, according to an embodiment of the present disclosure, the method includes applying dynamic feedback and domain options for push messages. A user flicks down the notification interface 312 (for example, quick panel) when a new push message comes. The user can enable options of his choice on the new push message (for example, web push messages). Further, cross domain advertisement may be shown either from original equipment manufacturer (OEM) manufacturer or the content provider apparatus 100. Further, the user can enable ‘Tag it” option for Live Contents Ex:—sports info messages, the user can enable ‘Archive’ option to save the message deals. Ex:—e-commerce, payment wallet deals. The user can enable ‘Request More’ to get such deals ex:—e-commerce websites. Further, the user can enable ‘Search’ option to get related content search using browser search like the search engines available. The user can enable ‘Like it’, ‘Dislike’ options to give instant feedback on messages. Further, the user can add more custom options; however the user may act on the messages from a domain. The static options are given by the content provider apparatus 100 (for example, ecommerce (ecommerce application) or websites).

In another example, the mobile device 300 may apply a predefined profile (e.g., theme and/or color) to the push message provided from the content provider apparatus 100 or to incoming push message. In addition, the predefined profile may apply to the push message both online and offline. Therefore, the mobile device 300 provides an immersive web application experience to the user of the mobile device 300.

Although FIGS. 10A, 10B, 10C, 10D, 10E, and 10F show a mobile device with a flat display but it is to be understood that other embodiments are limited thereon. A person having ordinary skill in the art can identify that the proposed disclosure can also be implemented on mobile devices with edge displays or any other notification area of the mobile device. For example, the push notification can be displayed in edge portion of the mobile device and all the action will be performed within the edge portion without opening any external application. Similarly, the push notification can be displayed on a notification area of a lock screen or any other customized notification area of the mobile device and all the action will be performed within the notification area without opening any external application. Further, the proposed disclosure can be extended to other categories of mobile devices, such as wearable device, head mounted displays, virtual reality apparatus, smart glasses, augment reality apparatus, and the like, without departing from the scope of the disclosure.

Further, although the above description is described based on a push message but it is to be understood that other embodiments are limited thereon. A person having ordinary skill in the art can identify that the proposed disclosure can also be implemented for any other messages, such as normal notification messages, web notifications, advertisement messages, and the like.

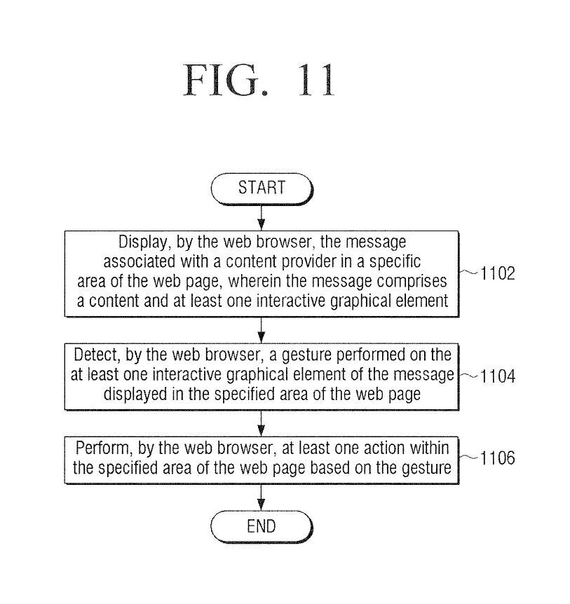

FIG. 11 is a flowchart illustrating a method for managing the messages by a mobile device 300 according to an embodiment of the present disclosure.

Referring to FIG. 11, at operation 1102, the mobile device 300 displays the message associated with the content provider apparatus 100 in a specific area of the web page, wherein the message comprises a content and at least one interactive graphical element. For example, in the mobile device 300, as illustrated in FIG. 5, the browser client module 304 (for example, web browser) may display the message associated with the content provider apparatus 100 in a specific area of the web page, wherein the message comprises a content and at least one interactive graphical element.

Further, at operation 1104, the mobile device 300 detects a gesture performed on the at least one interactive graphical element of the message displayed in the specified area of the web page. For example, in the mobile device 300, as illustrated in FIG. 5, the browser client module 304 may detect the gesture performed on the at least one interactive graphical element of the message displayed in the specified area of the web page.

Further, at operation 1106, the mobile device 300 perform at least one action within the specified area of the web page based on the gesture. For example, in the mobile device 300, as illustrated in FIG. 5, the browser client module 304 may perform the at least one action within the specified area of the web page based on the gesture.

For example, consider a scenario where the user receives the web push message (Deals from the e-commerce website) associated with a web application. The web push message includes at least one UI element (buy button). Further, the method includes receiving the user input on the UI element displayed in the web push message and executing a function (buying product) associated with the web application based on the received user input. The function is carried out within the web push message (without leaving the notification to open e-commerce website or application).

In yet another various embodiments herein provide an interactive push message service which enables a user to make payment on the push message interface itself without launching a separate application. The method includes a push message or notification which includes a product advertisement in the notification page, such as deals from some e-commerce website. Further, the method includes at least one UI element (buy button) provided along with the content. The UI element in response to a user action configured to trigger a function (buying product). The function is carried out within the notification page (without leaving the notification to open e-commerce application or website).

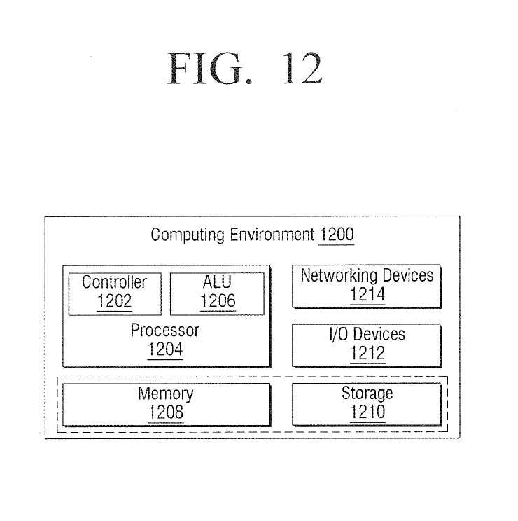

FIG. 12 is a computing environment implementing the method for managing the push messages in the mobile device (electronic apparatus) 300 according to an embodiment of the present disclosure. As depicted in FIG. 12, a computing environment 1200 comprises at least one processor 1204 that is equipped with a controller 1202 and an arithmetic logic unit (ALU) 1206, a memory 1208, a storage 1210, a plurality of networking devices 1214 and a plurality input/output (I/O) devices 1212. The processor 1204 is responsible for processing the instructions of the technique. The processor 1204 receives commands from the controller 1202 in order to perform its processing. Further, any logical and arithmetic operations involved in the execution of the instructions are computed with the help of the ALU 1206.

The overall computing environment 1200 can be composed of multiple homogeneous and/or heterogeneous cores, multiple CPUs of different kinds, special media and other accelerators. The processor 1204 is responsible for processing the instructions of the technique. Further, the plurality of processor 1204 may be located on a single chip or over multiple chips.

The technique comprising of instructions and codes required for the implementation are stored in either the memory 1208 or the storage 1210 or both. At the time of execution, the instructions may be fetched from the corresponding memory 1208 or storage 1210, and executed by the processor 1204.

In case of any hardware implementations various networking devices 1214 or external I/O devices 1212 may be connected to the computing environment to support the implementation through the networking unit and the I/O device unit.

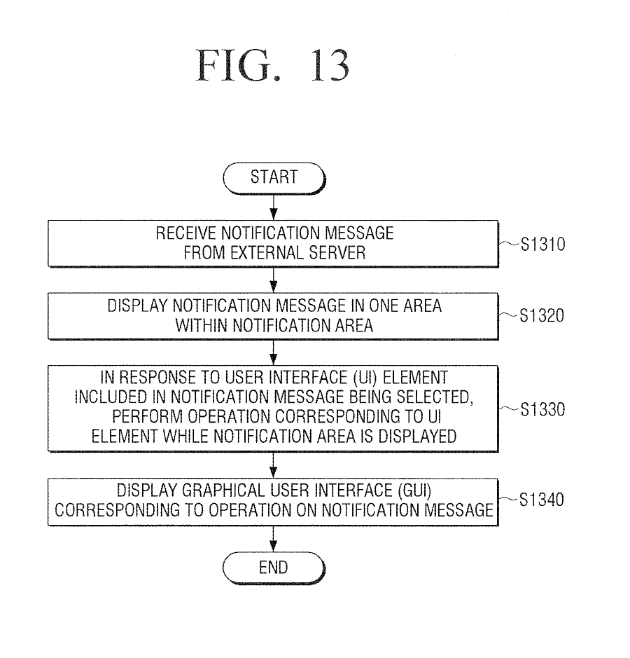

FIG. 13 is a flowchart illustrating a control method of an electronic apparatus according to an embodiment of the present disclosure.

FIG. 13 will be described with reference to the reference numerals shown in FIGS. 10A, 10B, 10C, 10D, 10E, and 10F.

Referring to FIG. 13, at operation S1310, the electronic apparatus 300 may receive a notification message regarding the content 1005 from an external server.

For example, the external server may be a content provider server to provide specific content information to the electronic apparatus 300. For example, the specific content may be related to products sold in a shopping mall. For example, there may be various products, such as digital media content, smartphone, food and beverages, clothes, and the like.

The notification message may be a customized push message provided from at least one external server.

At operation S1320, the electronic apparatus 300 may display a notification message 1002 including the content 1005 provided from an external server and a UI element 1006 regarding the content in an area within a notification area 1008.

The notification area 1008 may be displayed in at least one area of a display by a user's touch input (e.g., touch and touch-and-down, or a touch-and-drag), and may include other notification messages. For example, the larger the number of other notification messages, the larger the size of the notification area. In addition, the notification area may, in response to a specific user input (e.g., the clear icon 1001-1 or the home button 1001-2) being detected while the notification area is displayed, disappear from the display.

The notification message 1002 may include an icon (e.g., a web browser icon of a content provider) representing an external server that provided the content. In addition, the notification message 1002 may further include at least another UI element including information capable of changing or setting an option (background color, favorites setting, share, and the like) of the notification message.

For example, the UI element 1006 may include at least one of a payment icon 1006c for purchase of the content 1005 (e.g., a smartphone) and icons 1006a and 1006b for review of the content 1005.

At operation S1330, when a user input is detected on the UI element 1006, the electronic apparatus 300 may perform an operation (review, pay) corresponding to the selected UI elements 1006a, 1006b, and 1006c while the notification area 1008 is displayed.

At operation S1340, the electronic apparatus 300 may display a GUI (e.g., the graphical element 1004) corresponding to the selected UI element on the notification message 1002.

The electronic apparatus 300 may display a GUI corresponding to the selected UI element in an area other than the UI element 1006 on the notification message 1002. In addition, the electronic apparatus 300 may also display a GUI corresponding to the selected UI element in an area other than the UI element 1006 and the content 1005 on the notification message 1002. The GUI may be a web browser received from the external server.

When the payment icon 1006c for purchase of the content is selected, the electronic apparatus 300 may display an object (e.g., image of credit card illustrated in FIG. 10D) representing payment method stored in memory of the electronic apparatus 300 received from another external server (a server other than a content provider server). Meanwhile, when payment method of the user using the electronic apparatus 300 is stored in an external server that provided the notification message, the electronic apparatus 300 may skip this operation.

When a personal authentication input for payment by the user is received while an object is displayed, the electronic apparatus 300 may identify whether the personal authentication input matches with personal authentication information stored in memory of the electronic apparatus. In addition, the electronic apparatus 300 may receive identification information regarding whether the personal authentication input of the user matches with the information stored in the server through a server storing payment information, such as virtual currency, mobile currency, and the like.

The electronic apparatus 300 may, when it is identified that personal authentication information stored in memory or personal authentication information stored in an external server matches with personal authentication information input to the electronic apparatus 300 by the user, remove the object on the notification message and display a GUI regarding transaction confirmation of the content.

For example, the personal authentication input may be at least one of fingerprint recognition, iris recognition, voice recognition, security key input, and the like, but the example is not limited thereto.

The various embodiments disclosed herein can be implemented through at least one software program running on at least one hardware device and performing network management functions to control the elements. The elements shown in FIGS. 2 through 13 include blocks which can be at least one of a hardware device, or a combination of hardware device and software module.

The electronic apparatus 300 or method (for example, operations) according to various embodiments may be performed by at least one computer (for example, a processor 1204) which executes instructions included in at least one program from among programs which are maintained in a computer-readable storage medium.

When the instructions are executed by a computer (for example, the processor 1204), the at least one computer may perform a function corresponding to the instructions. In this case, the computer-readable storage medium may be the memory, for example.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

The instructions may include machine language codes created by a compiler, and high-level language codes that can be executed by a computer by using an interpreter. The above-described hardware device may be configured to operate as one or more software modules to perform the operations according to various embodiments of the present disclosure, and vice versa.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic apparatus comprising:
a display;
at least one processor; and
a memory configured to store one or more computer programs executed by the at least one processor,
wherein the at least one processor is further configured to:
in response to a notification message regarding a content being received from an external server, control the display to display a notification message including an image of the content and a user interface (UI) element regarding the content in one area of a notification area,
in response to a user input being detected on the UI element, control to perform an operation corresponding to the selected UI element while the notification area is displayed, and
control the display to display a graphic UI (GUI) corresponding to the operation on the notification message.

2. The electronic apparatus of claim 1, wherein the at least one processor is further configured to control the display to display a GUI corresponding to the operation in one area other than the UI element on the notification message, the GUI being a web browser received from the external server.

3. The electronic apparatus of claim 1, wherein the UI element comprises at least one of a payment icon for purchasing the content or an icon for reviewing the content.

4. The electronic apparatus of claim 3, wherein the at least one processor is further configured to, in response to an icon for payment of the content being selected, control the display to display an object representing a payment method stored in memory of the electronic apparatus received from another external server on the notification message.

5. The electronic apparatus of claim 4, wherein the at least one processor is further configured to:
in response to a personal authentication input for the payment by a user being received while the object is displayed, identify whether the personal authentication input matches with personal authentication information stored in a memory of the electronic apparatus; and
in response to identifying that the personal authentication input matches with personal authentication information stored in a memory of the electronic apparatus, control the display to remove the object and display transaction confirmation information of the content in the one area.

6. The electronic apparatus of claim 5, wherein the personal authentication input comprises at least one of fingerprint recognition, iris recognition, or voice recognition of the user.

7. The electronic apparatus of claim 1, wherein the at least one processor is further configured to:
control the display to display a navigation icon on the notification message; and
in response to the navigation icon being selected, control the display to display another notification message in the one area while the notification area is displayed.

8. The electronic apparatus of claim 1, wherein the notification message further comprises at least one other UI element including information capable of changing or setting an option of the notification message.

9. The electronic apparatus of claim 1,
wherein the notification message further comprises a registered identifier of the notification message, and
wherein a proxy server customizes a push message received from a content provider by adding the registered identifier in the received push message and transmits the customized push message as the notification message to the electronic apparatus.

10. The electronic apparatus of claim 9,
wherein, if the received push message comprises missing fields, the proxy server requests the content provider for the missing fields and customizes the received push message with the content received from the content provider, and
wherein, if the received push message comprises a predefined content provided from the content provider without missing fields, the proxy server transmits the customized push message along with the predefined content to the electronic apparatus.

11. A controlling method of an electronic apparatus, the method comprising:
receiving a notification message regarding a content from an external server;
displaying a notification message including the content provided from the external server and a user interface (UI) element regarding the content in one area of a notification area;
in response to a user input being detected on the UI element, performing an operation corresponding to the selected UI element while the notification area is displayed; and
displaying a graphic UI (GUI) corresponding to the operation on the notification message.

12. The method of claim 11, wherein the displaying of the GUI comprises displaying a GUI corresponding to the operation in an area other than the UI element, the GUI being a web browser received from the external server.

13. The method of claim 11, wherein the UI element comprises at least one of a payment icon for purchasing the content or an icon for reviewing the content.

14. The method of claim 13, wherein the performing further comprises, in response to a payment icon of the content being selected, displaying an object representing a payment method stored in a memory of the electronic apparatus received from another external server on the notification message.

15. The method of claim 14, wherein the displaying further comprises:
in response to a personal authentication input for the payment by a user being received while the object is displayed, identifying whether the personal authentication input matches personal authentication information stored in memory of the electronic apparatus; and
in response to identifying that the personal authentication input matches with personal authentication information stored in a memory of the electronic apparatus, removing the object and displaying transaction confirmation information of the content in the one area.

16. The method of claim 15, wherein the personal authentication input comprises at least one of fingerprint recognition, iris recognition, or voice recognition of the user.

17. The method of claim 11, wherein the displaying of the notification message further comprises:
displaying a navigation icon on the notification message; and
in response to the navigation icon being selected, displaying another notification message in the one area while the notification area is displayed.

18. The method of claim 11, wherein the notification further comprises at least one other UI element including information capable of changing or setting an option of the notification message.

19. The method of claim 11,
wherein the notification message further comprises a registered identifier of the notification message, and
wherein a proxy server customizes a push message received from a content provider by adding the registered identifier in the received push message and transmits the customized push message as the notification message to the electronic apparatus.

20. The method of claim 19,
wherein, if the received push message comprises missing fields, the proxy server requests the content provider for the missing fields and customizes the received push message with the content received from the content provider, and
wherein, if the received push message comprises a predefined content provided from the content provider without missing fields, the proxy server transmits the customized push message along with the predefined content to the electronic apparatus.
